(19) United States
(12) Patent Application Publication
(10) Pub. No.: US 2012/0130642 A1
(43) Pub. Date: May 24, 2012

(54) Downhole Tool Damage Detection System and Method

(75) Inventor: Hanno Reckmann, Humble, TX (US)

(73) Assignee: BAKER HUGHES INCORPORATED, Houston, TX (US)

(21) Appl. No.: 13/331,623

(22) Filed: Dec. 20, 2011

Related U.S. Application Data
(63) Continuation of application No. 12/331,023, filed on Dec. 9, 2008.
(60) Provisional application No. 61/014,601, filed on Dec. 18, 2007.

(51) Int. Cl. E21B 47/00; G06F 19/00

(52) U.S. Cl. 702/9; 73/152.58; 73/152.47

(57) ABSTRACT

A downhole tool damage detection method includes transmitting ultrasonic energy through a downhole tool, receiving ultrasonic energy transmitting through the downhole tool, monitoring the received ultrasonic energy for changes over time and alerting that at least partial unthreading of a threaded connection in the downhole tool may exist in response to finding the changes.

### CROSS REFERENCE TO RELATED APPLICATIONS

This application claims priority to U.S. Nonprovisional application Ser. No. 12/331,023, filed on Dec. 9, 2008 and U.S. Provisional Application No. 61/014,601, filed on Dec. 18, 2007, the entire contents of which are incorporated herein by reference.

### BACKGROUND OF THE INVENTION

Failures of downhole tools used in the hydrocarbon recovery industry are common Cracks in mechanical structures, such as drill strings and bottom hole assemblies, are one of the main reasons for downhole tool failures. Cracks may be detected at surface when a tool gets inspected. However, cracks often form and grow so quickly that detection at surface is not possible prior to a complete fracture of the tool occurring. The industry would, therefore, be receptive to a system for detecting tool damage while the tool is downhole.

### BRIEF DESCRIPTION OF THE INVENTION

Disclosed herein a downhole tool damage detection method. The method includes, transmitting ultrasonic energy through a downhole tool, receiving ultrasonic energy transmitting through the downhole tool, monitoring the received ultrasonic energy for changes over time and alerting that at least partial unthreading of a threaded connection in the downhole tool may exist in response to finding the changes.

Further disclosed herein is a downhole tool damage detection system. The system includes, at least one first transducer configured to transmit acoustic energy into a downhole tool while positioned downhole, at least one second transducer configured to receive acoustic energy propagated through the downhole tool while positioned downhole and at least one processor in operable communication with the at least one first transducer and the at least one second transducer. Additionally, the at least one processor is configured to monitor reception of the acoustic energy from the at least one second transducer for changes over time indicative of at least partial unthreading of a threaded connection.

Further disclosed herein is a downhole tool damage detection system. The system includes, a transducer configured to transmit acoustic energy into a downhole tool while positioned downhole and configured to receive acoustic energy propagated through the downhole tool, and at least one processor in operable communication with the transducer configured to attribute changes in acoustic energy received by the transducer with at least a partially unthreaded threaded connection in the downhole tool.

### BRIEF DESCRIPTION OF THE DRAWINGS

The following descriptions should not be considered limiting in any way. With reference to the accompanying drawings, like elements are numbered alike:

FIG. 1 depicts an embodiment of a downhole tool damage detection system disclosed herein monitoring a downhole tool without damage;

FIG. 2 depicts the downhole tool damage detection system of FIG. 1 monitoring a downhole tool with damage;

FIG. 3 depicts an alternate embodiment of a downhole tool damage detection system disclosed herein monitoring a downhole tool without damage; and

FIG. 4 depicts the downhole tool damage detection system of FIG. 3 monitoring a downhole tool with damage.

### DETAILED DESCRIPTION OF THE INVENTION

A detailed description of one or more embodiments of the disclosed apparatus and method are presented herein by way of exemplification and not limitation with reference to the Figures.

Embodiments disclosed herein transmit and receive ultrasonic energy through a tool, while the tool is positioned downhole, to determine when damage, such as a crack, for example, has formed. The system monitors ultrasonic energy propagating through the downhole tool for changes in the propagation. Such changes are analyzed and alerts are transmitted to notify a well operator that damage may be present.

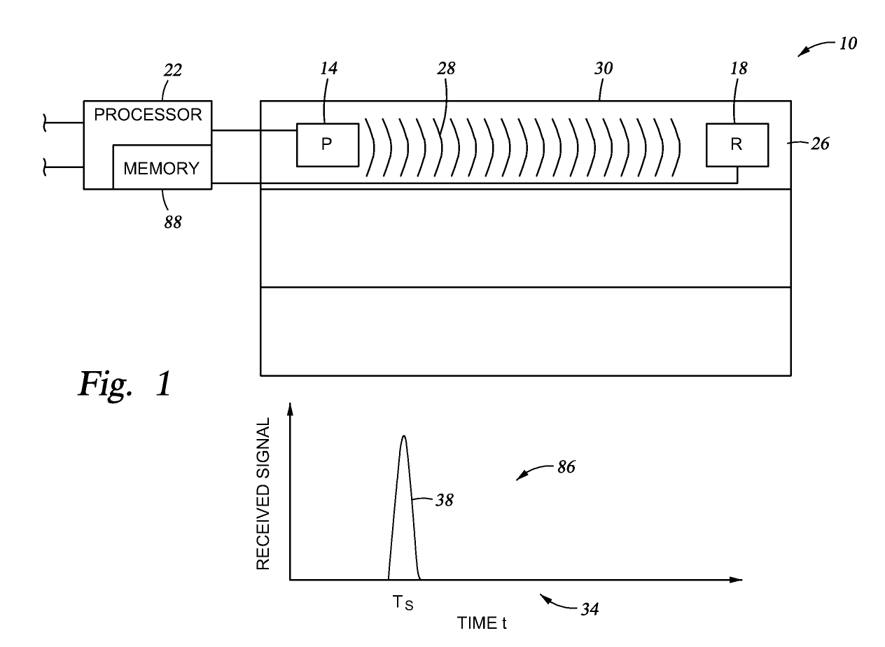

Referring to FIG. 1, an embodiment of a downhole tool damage detection system 10 is illustrated. The detection system 10 includes a first transducer 14, disclosed in this embodiment as a pulser labeled P, and a second transducer 18, disclosed in this embodiment as a receiver labeled R, and a processor 22. The transducers 14, 18 are mounted at a downhole tool 26 such that ultrasonic energy 28 can efficiently pass between the downhole tool 26 and each of the transducers 14 and 18. Such mounting may include a coupling fluid, as is typically desirable when using a piezoelectric transducer, for example, to improve conductance of ultrasonic energy between the tool 26 and the transducers 14, 18. Alternately, a transducer 14, 18 to tool 26 mounting may not benefit from a coupling fluid when using an embodiment with an electromagnetic-acoustic transducer (EMAT), as such fluids have proven to be unnecessary. A portion 30 of the downhole tool 26, located between the first transducer 14 and the second transducer 18, may be any portion of a downhole tool, such as a simple section of drill string pipe or a threaded coupling (not shown), as is typically found at pipe joints along drill strings, for example. The first transducer 14, being a pulser, is configured to pulse, or transmit, high frequency ultrasonic energy 28, into the downhole tool 26. The ultrasonic energy 28 propagates through the downhole tool 26 in the form of waves. The second transducer 18, being a receiver, is configured to receive ultrasonic energy 28 transmitted through the downhole tool 26. The processor 22 is configured to control the transmitting of the first transducer 14 as well as to monitor and record ultrasonic signals based on the ultrasonic energy 28 transmitted through and received by the second transducer 18. As such, the processor can measure the duration of time from when the first transducer 14 transmits ultrasonic energy, to when the second transducer 18 receives the transmitted ultrasonic energy 28. This sequence is shown graphically in chart 34, which has a vertical axis for amplitude of the received energy signal and a horizontal axis for elapsed time.

Chart 34 shows a single, simple received signal 38 that is displaced a time Tₛ from when the energy 28 was transmitted. This time Tₛ is determined, in part, by the speed with which the ultrasonic waves propagate through the downhole tool 26 from the first transducer 14 to the second transducer 18. The received signal 38, as depicted herein, is a simplified representation of what an actual received signal would be. An actual received signal will have significantly more detail due to multiple reflections that occur as the waves propagate through the downhole tool 26, as they travel from the first transducer 14 to the second transducer 18. At least a portion of the ultrasonic waves are reflected every time they encounter an impedance change. Impedance changes exist at geometric changes in the structure, such as walls and cracks, for example. As such, a received signal, from a single transmitted ultrasonic pulse, will likely be spread over a longer time duration than a time duration of the transmitted pulse. This expansion of time is due to multiple reflections causing longer travel paths, and consequently, longer travel times for some of the wave energy 28 to reach the second transducer 18. Additionally, the received signal 38 will have multiple amplitudes for at least two reasons. First, because the ultrasonic energy 28 decreases the further it propagates, and second, because the ultrasonic energy 28 is divided due to impedance changes that are, for example, only partially protruding through a wall of the structure, thereby reflecting only a portion of the energy 28 while not reflecting the balance of the energy 28. The actual received signal 38 is, therefore, a complex waveform of varying amplitude over a duration of time.

Such complex waveforms can create difficulty in detecting damages if, for example, two received signals are compared from different, and unique structures. In such cases, the complex waveforms can be so different that concluding anything definitively based on comparing them would in most cases be improbable. Some embodiments disclosed herein, however, compare signals received from a single structure that has changed over time (by the addition of damage). As such, the complex waveform remains basically unchanged until damage forms. Any change in the waveform at all can, therefore, be at least suspected of being caused by damage. An illustration of this follows.

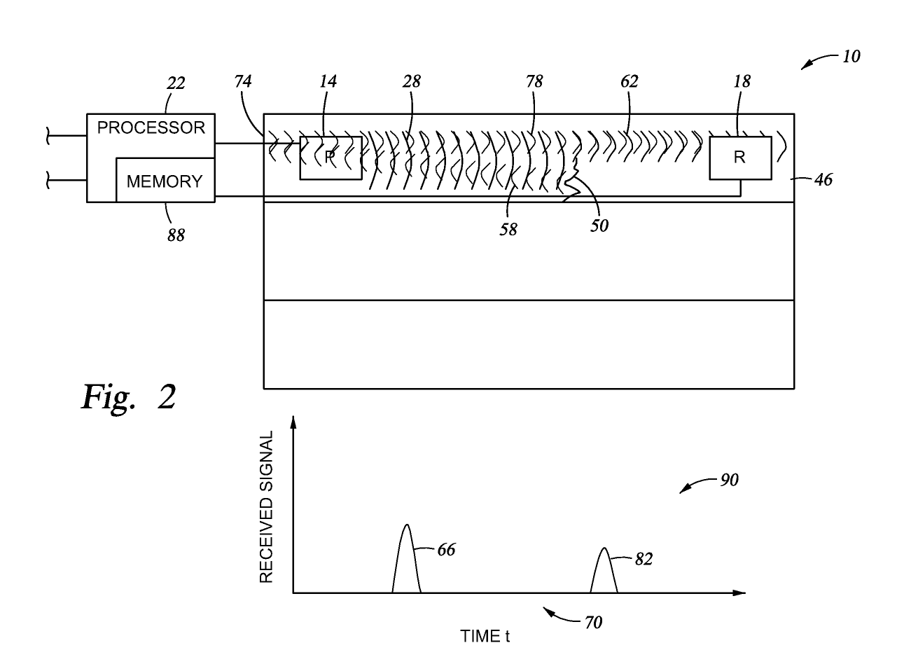

Referring to FIG. 2, an embodiment of the downhole tool damage detection system 10 is shown being applied to a downhole tool 46 having damage 50. The damage 50, as illustrated in the downhole tool 46, is a crack. Ultrasonic energy 28 transmitted from the first transducer 14, during propagation through the downhole tool 46, encounters the damage 50. The change of impedance caused by the damage 50, reflects a portion of the energy 58, while leaving a portion relatively unaffected 62. The unaffected portion 62, is received by the second transducer 18, resulting in a signal 66 on chart 70 of received energy versus time. A comparison of the signal 66 to the signal 38 (FIG. 1) reveals that the signal 66 has less amplitude than the signal 38. Assuming that the transmitted energy pulses were the same, this demonstrates the loss of amplitude that has resulted from the reflected portion 58, being divided from the transmitted ultrasonic energy 28 prior to reaching the second transducer 18. The reflected portion 58 propagates back and reflects off surface 74, as reflected energy 78, that is finally received at the second transducer 18. Receipt of the reflected energy 78 creates signal 82 on the chart 70, that is delayed relative to the signal 66, due to an increased distance traversed. It should also be noted that the amplitude of the signal 82 is less than the amplitude of the signal 66. This amplitude difference can be due, in part, to the energy dissipated over the increased travel distance, and, in part, due to only a portion of the total energy 28 being reflected by the damage 50. As such, by observing the changes from the chart 34 to the chart 70, a determination that damage may now exist can be made. Upon determining that damage may have formed, the damage detection system 10 can send an alert that damage may have occurred.

In applications that have the processor 22 located downhole, such alert can be through telemetry to surface, for example. While some embodiments disclosed herein may have the processor 22 located downhole, others may have the processor 22 located remotely such as at surface, for example. Deciding on where to locate the processor 22 may best be based upon the bandwidth available at different locations. Since the amount of data being communicated between the transducers 14, 18 and the processor 22 is likely large, in comparison to the amount of data communicated between the processor 22 and surface, it may be preferable to locate the processor 22 downhole near the transducers 14, 18. In applications, however, that have significant bandwidth between downhole and surface, such as those utilizing wired pipe for example, an alternate embodiment, with the processor 22 located at surface, may be preferred. The processor 22 simply needs to be able to receive data from the transducer 18 representative of ultrasonic signals received by the transducer 18 and perform signal processing regardless of where the processor 22 is located.

The processing, discussed above, consists of analyzing the received ultrasonic energy for changes over time. Thus, storing the chart 34, of the signal 38 that is defined herein as signature 86, may be desirable for comparison to the chart 70, of the signals 66, 82 that are defined herein as signature 90. Thus memory 88, shown in this embodiment as part of processor 22, is used for such storage. The memory 88 could be used to increase confidence that a detected change in the received signatures 86 and 90 is actually due to damage 50 in the tool 46. A signature for a tool with known damage, similar to the signature 90, for example, could be stored in the memory 88. The stored signature 90 could then be used to compare to a received signature that is suspected of identifying tool damage. The closer a match between the received signature and the stored signature 90, the greater the confidence that the received signature is indeed identifying actual tool damage. This method could be further used to identify a type of damage, and possibly even a severity of damage. Doing so may require storing several signatures for tools having damage of varying types and varying severities. With such damage catalogued in the memory 88, a comparison could be made to find which type and severity of damage best matches a newly received signature. Such information could then also be used in the alert.

Alternate methods of processing the received signals may also be used to detect damage in a downhole tool. For example, the processor 22 may, instead of analyzing a signature directly, analyze a transfer function that it has generated. A transfer function is a mathematical representation of the relation between the input and the output of a system. Comparing transfer functions of complex waveforms is often easier than comparing the complex waveforms directly. In such an embodiment, the processor 22 will generate a transfer function between the transmitted energy signature and the received energy signature. This transfer function can then be monitored over time for changes. Such changes, when encountered, could be attributed to the development of damage in the downhole tool initiating an alert as discussed above. An alternate embodiment could also compare the transfer function of a tool suspected of having damage to transfer functions from a catalogue of stored transfer functions from tools with damage of known types and severity levels. As with the catalogue of signatures, this catalogue of transfer functions would then allow for categorizing the type of and severity of suspected damage.

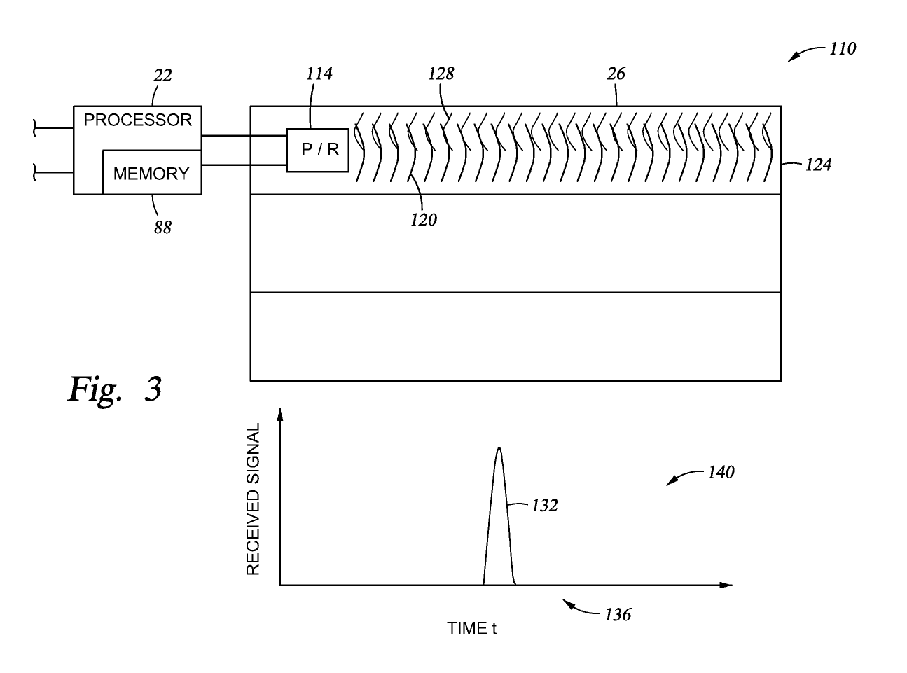

Referring to FIG. 3, an alternate embodiment of a downhole tool damage detection system 110 is illustrated. The damage detection system 110 is similar in operation to that of the damage detection system 10 and as such only the differences between the two systems 10 and 110 will be discussed here. Instead of having two separate transducers 14 and 18, as the system 10 has with the first transducer 14 for transmitting energy and the second transducer 18 for receiving energy, the embodiment of the system 110 has just a single transducer 114. The transducer 114 acts as both a pulser and receiver and as such can both transmit and receive ultrasonic energy and is thus labeled P/R. In this simplified illustration, transmitted ultrasonic energy 120 propagates through the downhole tool 26 and reflects off surface 124 as reflected energy 128. The reflected energy 128 propagates through the tool 26 and is received by the transducer 114. The processor 22, in communication with the transducer 114, controls transmission of the energy 120 as well as monitors reception of the received energy 128. A received signal 132 on chart 136 defines signature 140. The signature 140 remains substantially constant until a change to the downhole tool 26, such as damage occurs, for example, resulting in impedance changes and changes in reflection of the propagating ultrasonic energy 120.

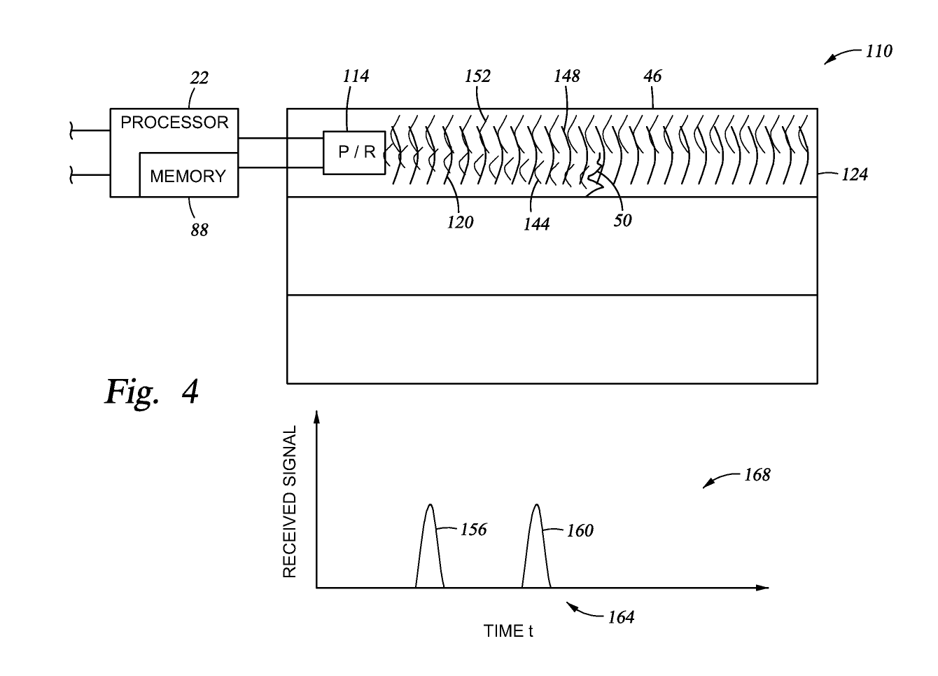

Referring to FIG. 4, the embodiment of the downhole tool damage detection system 110 is illustrated being applied to the downhole tool 46, which has the crack (damage) 50. As in FIG. 3, ultrasonic energy 120 transmitted from the transducer 114, during propagation through the downhole tool 46, encounters the damage 50. The change of impedance caused by the damage 50, reflects a portion of the energy 144, while leaving a portion unaffected 148. The unaffected portion 148 continues to propagate until it encounters the wall 124, off of which it reflects as energy 152. The transducer 114 receives both the portion 144 and the reflected energy 152 resulting in signals 156 and 160 respectively, on chart 164 defining signature 168. The processor 22 can use the signature 168; in the same manner that it used signature 90, to identify changes in signals received and detection of damage therewith. Similarly, the signature 168 can be used in the generation of transfer functions, as described above, to detect damage in the tool 46.

In an alternate embodiment of the damage detection system 10 disclosed herein, the transducers 14 and 18 may both be able to transmit as well as receive ultrasonic energy in the same manner as transducer 114. Such an embodiment would allow for increased feedback through combining the results of controlling the transducers 14, 18 as follows. The second transducer 18 could transmit ultrasonic energy into the tool 46 while the first transducer 14 would receive the ultrasonic energy transmitted through the tool 46, in essence reversing the direction of propagation of the energy through the tool. In so doing the time to receive energy reflected from the damage 50 by the second transducer 18 would be less than the time to receive energy reflected from the first transducer 14 if the damage were located closer to the second transducer 18 than the first transducer 14 as is illustrated in FIG. 2. Comparing a signature (not shown) for this embodiment to the signature 90 would allow an operator to more accurately locate the damage 50 relative to the transducers 14, 18. Additionally, this embodiment would permit each of the two transducers 14, 18 to function in the same manner as the transducer 114, specifically, performing both the transmitting and the receiving functions. Again, through combining the results from each of the transducers 14, 18 would provide greater detail of the damage 50 than with either transducer 14, 18 operating in a fashion independent of the other.

Although the damage 50 discussed thus far has been described as a crack, it should be clear that the downhole tool damage detection systems 10, 110, disclosed herein, could detect other damage as well. For example, when applied across a threaded connection, between downhole tubulars for example, the system could detect an unthreading of the tubulars that creates very small gaps that fill with a fluid or a gas.

Additionally, embodiments of the downhole tool damage detection systems 10, 110, disclosed herein, could be applied to downhole tools 26, 46 while the downhole tools are in operation, such as while drilling a wellbore, for example. Such simultaneous operation is possible because the frequencies of the ultrasonic energy, utilized by the transducers 14, 18 and 114, are much so higher than those generated by the borehole drilling equipment, while drilling, that the transducers 14, 18 and 114 are not detrimentally affected by the drilling created frequencies.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the claims.

What is claimed:

1. A downhole tool damage detection method, comprising:
transmitting ultrasonic energy through a downhole tool;
receiving ultrasonic energy transmitting through the downhole tool;
monitoring the received ultrasonic energy for changes over time; and
alerting that at least partial unthreading of a threaded connection in the downhole tool may exist in response to finding the changes.

2. The downhole tool damage detection method of claim 1, wherein the transmitting ultrasonic energy through the downhole tool includes reflecting the transmitted ultrasonic energy at differences of impedance within the downhole tool.

3. The downhole tool damage detection method of claim 1, wherein the transmitting and the receiving are with a single transducer.

4. The downhole tool damage detection method of claim 1, wherein the transmitting is from a first transducer and the receiving is with a second transducer.

5. The downhole tool damage detection method of claim 4, wherein the transmitting is from the second transducer and the receiving is with the first transducer and the receiving with the first transducer is compared to the receiving with the second transducer.

6. The downhole tool damage detection method of claim 1, wherein the monitoring the received ultrasonic energy includes generating multiple signatures over time with the receiving of the ultrasonic energy.

7. The downhole tool damage detection method of claim 6, further comprising monitoring the multiple signatures generated for changes over time.

8. The downhole tool damage detection method of claim 6, further comprising comparing the multiple signatures generated to stored signatures of downhole tools having at least a partially unthreaded threaded connection.

9. The downhole tool damage detection method of claim 6, wherein the generating multiple signatures is continuous.

10. The downhole tool damage detection method of claim 1, wherein the monitoring the received ultrasonic energy includes generating multiple transfer functions over time for the ultrasonic energy received versus the ultrasonic energy transmitted.

11. The downhole tool damage detection method of claim 10, further comprising monitoring the multiple transfer functions generated for changes over time.

12. The downhole tool damage detection method of claim 11, further comprising comparing the multiple transfer functions generated to stored transfer functions of downhole tools having an at least partially unthreaded threaded connection.

13. The downhole tool damage detection method of claim 1, wherein the alerting further comprises telemetrically transmitting uphole.

14. The downhole tool damage detection method of claim 1, wherein the monitoring is performed while drilling.

15. A downhole tool damage detection system, comprising:
at least one first transducer configured to transmit acoustic energy into a downhole tool while positioned downhole;
at least one second transducer configured to receive acoustic energy propagated through the downhole tool while positioned downhole; and
at least one processor in operable communication with the at least one first transducer and the at least one second transducer, the at least one processor configured to monitor reception of the acoustic energy from the at least one second transducer for changes over time indicative of at least partial unthreading of a threaded connection.

16. The downhole tool damage detection system of claim 15, further comprising a data storage device configured to store data of a downhole tool with at least a partially unthreaded threaded connection and the at least one processor being configured to compare the data stored for the downhole tool with at least a partially unthreaded threaded connection to data acquired while the downhole tool is downhole.

17. The downhole tool damage detection system of claim 15, wherein the at least one processor is configured to transmit alerts of a tool with an at least partially unthreaded threaded connection uphole via a telemetry system.

18. A downhole tool damage detection system, comprising:
a transducer configured to transmit acoustic energy into a downhole tool while positioned downhole and configured to receive acoustic energy propagated through the downhole tool; and
at least one processor in operable communication with the transducer configured to attribute changes in acoustic energy received by the transducer with at least a partially unthreaded threaded connection in the downhole tool.
